(19) United States
(12) Patent Application Publication
(10) Pub. No.: US 2002/0198741 A1
(43) Pub. Date: Dec. 26, 2002

(54) Medical billing system and method

(76) Inventor: Philip Randazzo, Las Vegas, NV (US)

Correspondence Address: MONIQUE A. MORNEAULT, ESQ., WALLENSTEIN & WAGNER, 311 South Wacker Drive-5300, Chicago, IL, 60606, US

(21) Appl. No.: 10/100,358

(22) Filed: Mar. 18, 2002

Related U.S. Application Data
(60) Provisional application No. 60/300,502, filed on Jun. 22, 2001.

(51) Int. Cl. G06F 17/60

(52) U.S. Cl. 705/3

(57) ABSTRACT

A method and system for processing medical claims resulting from the treatment of a patient by a healthcare provider, including processing the claim by a third party database to identify errors in the claim prior to submission to an indemnitor, is disclosed.

### TECHNICAL FIELD

This invention relates to general solution for the processing of medical claims and the early payment of amounts associated with medical claims composed principally of a method and system for enabling a healthcare provider (“Provider”) to: (a) connect with and utilize a third party Facilitator's (“Facilitator”) application service provider (“ASP”) for the processing of medical claims, (b) create, verify and correct medical claims through a series of checks, comparisons and revisions aided and generally utilizing the ASP prior to submittal of such claims to an indemnitor (“Indemnitor”) or other obligated party (any Indemnitor or other obligated party being an “Obligated Party”), (c) submit the resulting clean, accurate and complete medical claims (“Clean Claim”) electronically through a clearinghouse facility for ultimate delivery to the Obligated Party, (d) field electronically and on an automated basis corrections from a clearinghouse facility with respect to the Clean Claims; (e) generate electronically and on an automated basis new Clean Claims based upon clearinghouse facility changes, (f) monitor and track clearinghouse facility processing of Clean Claims to the Obligated Party, and (g) provide the Provider with a substantial percentage of funds associated with the Clean Claim substantially prior to actual payment of required amounts from the Obligated Party.

### BACKGROUND OF THE INVENTION

The health care industry does not have a solution for coupling the processing of medical claims on a semi-automated basis through computerized and electronic means with the ability to make advance payments on such claims. The ability to make advance payments is engendered by both the economies of scale computerized and electronic, semi-automated processing achieves, as well as, the ability of that processing to minimize greatly the human error that results in Indemnitors expending inordinate amounts of time in making responsive payments to medical claims generated by Providers.

Errors are associated with improperly submitted claims. A properly submitted claim must have certain fields filled and such fields must contain correct information, including, without limitation, patient information, treatment codes and Provider fees. The different formats required by the various Indemnitors, combined with different treatment codes, fee schedules, and policy coverages associated with services rendered by the Provider is one cause of erroneous submitted claims, producing significant delays, inefficiencies and costs.

A computerized and electronically driven program incorporating Indemnitor specific data with timely updates as well as automated error prompts greatly reduces the incidence of error and thus enables an assurance of more timely Indemnitor payment. By achieving more timely Indemnitor payment, the provider of the claimed solution may safely make advance payments of Clean Claim amounts to Providers that equal a percentage of the actual payments from the Indemnitor. The percentage not paid operates as a fee for the services and the advance payments. The Provider's ability to receive advance payments, although less than what would have been actual payments, is economically and rationally justified by not only the time value of money but also the assurance of payment.

Currently, approximately one-half of all claims submitted to Indemnitors are erroneously submitted (“Erroneous Claims”). Erroneous Claims must be returned, corrected and re-submitted as Clean Claims before the Indemnitor can or will determine the coverage and appropriate payments for such Clean Claims. Such a delay can result even if the error is a minor typographical error. The time exhausted to correct and re-submit claims creates several inefficiencies and costs for the Provider, including, without limitation: (a) labor costs for correction and re-submittal, (b) greater work load for an often over-worked Provider's staff, and (c) greater likelihood of additional errors, requiring more time and money to review each claim submitted or re-submitted.

Even upon submittal of a Clean Claim, the Indemnitor must take the necessary time to review the Clean Claims and compare such Clean Claims with the Provider's fee schedules and patient policy requirements to determine the Indemnitor's contracted payments related to the Clean Claims. Therefore, the Provider will not receive payment in a timely manner and is unable to capitalize on the services rendered until a significant time period has elapsed.

The present invention is designed to solve these and other problems.

### SUMMARY OF INVENTION

The present invention provides a method and system, which includes enabling a Provider to connect with and directly utilize a Facilitator's ASP from a remote location for processing medical claims. The ASP itself intrinsically provides a software solution in which Indemnitor-specific data is populated enabling the automated error identification, prompting and correction of claim specific data. Through the operation within the Provider's facilities utilizing the ASP, the Provider is able to create, verify and correct medical claims through a series of checks, comparisons and revisions aided and generally utilizing the ASP. The Provider is then enabled to submit with rapidity Clean Claims electronically through a clearinghouse facility for ultimate delivery to the Obligated Party. The Provider is enabled to parametrically field electronically and on an automated basis corrections from a clearinghouse facility with respect to the Clean Claims. Upon fielding those corrections, the Provider can generate electronically and on a automated basis new Clean Claims and repeat the process of transmitting new Clean Claims. The Provider is able to, through the assistance of the solution provider, to monitor and track clearinghouse facility processing of Clean Claims to the Obligated Party. Finally, the Provider receives up-front a substantial percentage of funds associated with the Clean Claim prior to actual payment of required amounts from the Obligated Party.

Thus, the present invention provides a method for processing a claim for treatment of a patient by a healthcare provider for submission to an indemnitor, the method comprising creating an electronic claim containing patient information, the claim being for an amount of money, then processing the claim by a third party facilitator via a database of verification codes to identify errors in the patient information prior to initial submission of the claim to the indemnitor. Advanced payment is provided by the third party facilitator to the healthcare provider. The method further includes submitting the claim to the indemnitor for payment of the amount of money, and the third party receiving payment of the amount of money from the indemnitor.

Other features and advantages of the invention will be apparent from the following specification taken in conjunction with the following figure.

### BRIEF DESCRIPTION OF THE DRAWINGS

FIG. 1 is the schematic drawing of the present invention.

### DETAILED DESCRIPTION

While this invention is susceptible of embodiment in many different forms, the drawing shows and the description herein describes in detail a preferred embodiment of the invention with the understanding that the present disclosure is the be considered as an exemplification of the principles of the invention and is not intended to limit the broad aspect of the invention to the embodiment illustrated.

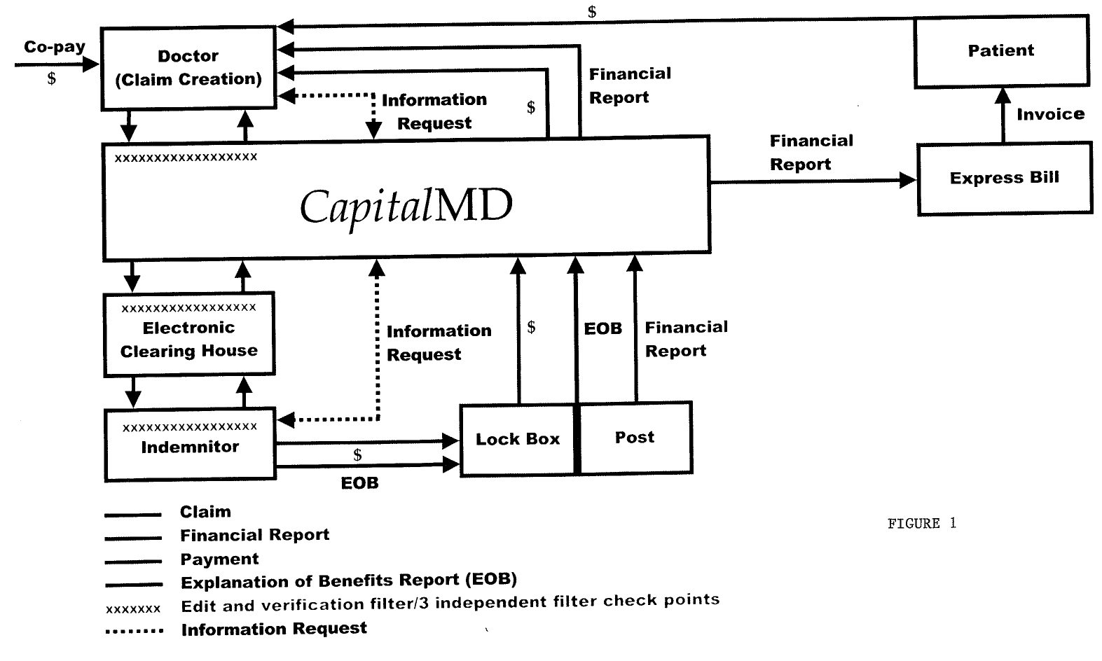

As illustrated in FIG. 1, the present invention is an improved method and system for processing claims for payment by an Indemnitor by enabling a Provider to create, verify and correct a claim prior to submission to such Indenmitor and receive the working capital for such submitted claims prior to actual payment from the Indemnitor. When a patient visits the Provider's office, the patient will disclose relevant personal information, including, without limitation, insurance information, to the Provider's staff. The information is kept and maintained in the Provider's records system. When each incidence of service or visit is completed, the patient information, combined with specific treatment codes corresponding with the services rendered, called Classified Procedures and Treatment (CPT) codes, and the fees associated with such services are required to create an electronic Initial Claim.

Once the Initial Claim is created, the Initial Claim is verified using a third party Facilitator's ASP system incorporating a database containing verification codes, including, without limitation, patient information, CPT codes and fee schedules by and between the Indemnitor and the Provider. The data and software necessary for editing, validating and transmitting a claim are stored and accessed at the Facilitator's independent facility, located off-site from the Provider's office. The verification process includes cross-checking and comparisons with the verification codes in the database. This real-time verification is an improvement over prior systems where such verification code information generally reside in unconnected locations, making simultaneous verification difficult or impossible.

If the verification system detects errors or omissions, the Provider's staff is instantaneously notified of such error or omission. The staff would then be allowed to correct any errors or omissions prior to submission to the Obligated Parties. In fact, the system will not allow the staff to submit the Initial Claim to the Obligated Parties until the required information is complete and correct. The instant notification is similar to an on-line ordering process used when placing an order for products on a website, which is well known in the art, whereby the buyer would receive a warning if certain required information, such as an address or city, has not been entered.

Please note that the system will simply notify the staff of a problem with the Initial Claim, but will not automatically correct the missing or erroneous information as such correction must be accomplished by the Provider. After the error is corrected, the staff will re-submit the Initial Claim through the Facilitator's ASP system for further verification.

Once the Initial Claim is verified or becomes a Clean Claim, the Clean Claim is submitted to an independent third party clearinghouse (“Clearinghouse”) for adjudication. Once the Clean Claim is submitted, the staff can use the Facilitator's ASP to generate a customized report for the patient's records even before the patient leaves the Provider's office. Additionally, the Provider can determine the amount the Indemnitor will likely pay for the services rendered to the patient and the amount to subsequently bill the patient.

Furthermore, once the claim is verified, the Provider is credited with an advance payment from the Facilitator. The advanced payment are credited on a monthly basis on regular intervals, such as every 15 days. The Provider is credited an amount equal to 100% of the claims submitted based upon the insurance fee schedule, less a fee paid to the Facilitator and a reserve fund used to offset any claim denied or subject to offset by the Obligated Parties. The Provider is therefore able to utilize the working capital of services rendered on regular intervals due to the accuracy of the verification system and even before the claim has been completed processed and paid by the Obligated Parties. This advanced payment of medical claims to the healthcare provider is an improvement over the way in which claims are presently processed and handled. Prior to this method and system, Providers were required to wait a significant amount of time before receiving payments on claims from Obligated Parties.

If the Submitted Claims contain technical errors or missing data elements that are detected by the Clearinghouse that effectively negates the ability of the Clearinghouse or Indemnitor's information system to read or verify the Submitted Claim, the Submitted Claim is rejected and must be re-submitted within twenty (24) hours of the initial Submitted Claim. The Clearinghouse would notify the Facilitator of any errors or omissions. The Facilitator would then interface between the Provider's staff and the Clearinghouse to coordinate and obtain the information required for the Provider's staff to correct and re-submit the Submitted Claim within the specified time period using the Facilitator's ASP system. As previously noted, any corrections to the claims must be made by the Provider and cannot be made by the Facilitator.

The Clearinghouse will edit and format the Submitted Claim, if required, to bring the Submitted Claim into compliance with the specific format required by an individual Indemnitor's standards. If the Submitted Claim is correct and does not contain any technical errors, the Submitted Claim is transmitted to the Indemnitor for processing. The Indemnitor may further edit the Submitted Claim on patient-specific criteria, including patient eligibility and benefits, and verify whether the Submitted Claim is a Clean Claim. The Facilitator's ASP system and method provides greater certainty that the Submitted Claim is a Clean Claim when the claim is submitted to the Clearinghouse and subsequently to the Indemnitor. A Clean Claim, as identified by the Indemnitor, receives final adjudication and payment from the Indemnitor.

When the Facilitator receives payment on the Submitted Claim, whether through the Indemnitor, the Provider (if such payment was sent to the Provider) or the patient, the Facilitator makes the necessary reconciliation with respect to the advance payments. If not already issued, the Facilitator issues a patient statement on behalf of the Provider to collect any remaining amounts owed by the patient.

While the specific embodiments have been illustrated and described, numerous modifications are available without significantly departing from the spirit of the invention. Therefore, the scope of protection is only limited by the scope of the accompanying claims.

1. A method for processing a claim for treatment of a patient by a healthcare provider for submission to an indemnitor, the method comprising:
creating an electronic claim containing patient information, the claim being for an amount of money;
processing the claim by a third party facilitator via a database of verification codes to identify errors in the patient information prior to initial submission of the claim to the indemnitor;
providing an advance payment by the third party facilitator to the healthcare provider;
submitting the claim to the indemnitor for payment of the amount of money; and,
receiving the payment of the amount of money by the third party from the indemnitor.

2. The method of claim 1 wherein the step of creating an electronic claim includes opening an electronic file by the healthcare provider.

3. The method of claim 1 wherein creating the claim includes on-line editing using a series of verification codes.

4. The method of claim 3 wherein the verification codes include patient demographic information.

5. The method of claim 3 wherein the verification codes include healthcare provider fees.

6. The method of claim 3 wherein the verification codes include classified procedures and treatment codes.

7. The method of claim 3 wherein the verification codes are centrally located on software through an application service provider.

8. The method of claim 7 wherein the software containing the verification codes can be accessed and updated by the third party facilitator.

9. The method of claim 1 wherein processing the claim includes cross-checking information in the claim with the verification codes.

10. The method of claim 1 wherein processing the claim can be performed by the application service provider.

11. The method of claim 1 wherein processing the claim further includes returning a claim containing erroneous patient information to the healthcare provider for correction.

12. The method of claim 1 wherein providing an advance payment to the healthcare provider includes electronic transfer of funds at a set interval.

13. The method of claim 11 wherein the advance payment is less than the amount of money in the claim.

14. The method of claim 12 wherein the advance payment is a fixed percentage of the amount of money in the claim.

15. The method of claim 12 wherein the advance payment is a fixed percentage of the amount of money in the claim less further a percentage for a reserve fund.

16. The method of claim 1 wherein processing the claim further includes facilitating a subsequent verification of the claim through an electronic clearinghouse.

17. The method of claim 15 wherein the clearinghouse notifies the third party facilitator of errors in the claim.

18. The method of claim 16 wherein the electronic clearinghouse further edits the claim, including formatting the claim according to individual indemnitor standards.

19. The method of claim 16 wherein the formatted claim is submitted to the indemnitor.

20. The method of claim 16 wherein the formatted claim is further evaluated for correctness by the indemnitor.

21. The method of claim 16 wherein the formatted claim paid by the indemnitor.

22. The method of claim 1 wherein the process further includes billing the patient for outstanding amounts due.

23. The method of claim 1 wherein receiving the payment from the indemnitor further includes following-up with the indemnitor on unadjudicated claims.

24. A billing system for submitting medical claims created by a healthcare provider for pre-payment approval comprising:
an electronic medical claim containing patient information;
a means for processing the claim by a third party via a database of verification codes and to identify errors in the claim prior to initial submission of the claim for payment by an indemnitor; and,
a means for advancing payment of the claim to the healthcare provider prior to payment by the indemnitor.

25. The billing system of claim 23 wherein the means for processing the claim includes on-line editing of the claims using a series of verification codes.

26. The billing system of claim 24 wherein the means for processing the claim includes immediate electronic notification of errors in the claim.

27. The billing system of claim 24 wherein the means for processing the claim further includes correction of the errors by the healthcare provider and re-submission of the claim for verification.

28. The billing system of claim 24 wherein the means for processing the claim includes second verification of the claim at an electronic clearinghouse for further identification of errors.

29. The billing system of claim 24 wherein the means for advancing payment to the healthcare provider includes electronic transfer of funds at regular intervals.

30. The billing system of claim 24 wherein the means for advancing funds includes submission of a complete, correct and clean claim to the indemnitor.

31. A method for processing a claim for treatment of a patient by a healthcare provider for submission to an indemnitor, the method comprising:
providing a software having a matrix for creating a claim for an amount of money;
creating an electronic claim containing patient information, using the software;
processing the claim through a first tier filtering process using a third party application service provider having a software database containing verification codes to identify errors in the patient information prior to submission of the claim to the indemnitor;
processing the claim through a second tier filtering process using a clearinghouse for further verification and identification of errors in the claim;
providing an advance payment by the third party to the healthcare provider;
submitting the claim through a third tier filtering process to the indemnitor for approval and subsequent payment of the amount of money; and,
receiving the payment of the amount of money by the third party from the indemnitor; and,
following up by the third party with indemnitor concerning any nonpayment on the claim.
